(19) United States
(12) Patent Application Publication
(10) Pub. No.: US 2004/0002166 A1
(43) Pub. Date: Jan. 1, 2004

(54) Remote analysis using aerosol sample transport

(76) Inventor: Daniel R. Wiederin, Omaha, NE (US)

Correspondence Address: BLACKWELL SANDERS PEPER MARTIN LLP, TWO PERSHING SQUARE, 2300 MAIN STREET, SUITE 1000, KANSAS CITY, MO, 64108, US

(21) Appl. No.: 10/184,198

(22) Filed: Jun. 27, 2002

(51) Int. Cl. G01N 1/22

(52) U.S. Cl. 436/181; 436/52; 422/81; 422/83

(57) ABSTRACT

Systems and methods are disclosed that use a nebulizer for remote aerosol generation and then transport the aerosol by way of, for example, an argon gas stream through tubing. By transporting the chemical to be analyzed in aerosol form, transport time is reduced from about 30 minutes to less than one minute, using a relatively small amount of sample, and enabling the accurate, remote analysis of a variety of chemicals, including relatively high pH chemicals.

### FIELD OF INVENTION

The present invention relates to systems and methods for use in chemical analysis systems. More particularly, the present invention relates to remote analysis of samples using aerosol sample transport.

### BACKGROUND OF INVENTION

In industrial applications, it is useful to periodically sample chemicals for the presence of undesired impurities. For example, in the semiconductor fabrication industry, cleaning solutions are used to remove impurities from the surface of semiconductor wafers during various fabrication processes. During cleaning processes, contaminants can enter a cleaning solution from sources, such as semiconductor wafers that come into contact with the solution, from an operator of the associated cleaning equipment, or from deterioration of valves or storage containers. Further, for some industrial applications, pure chemicals are called for, and it is useful to test for purity of the chemicals, by analyzing the chemicals. By way of another example, in the petrochemical industry, it is useful to monitor levels of certain elements, such as sulfur, in process streams.

Known methods of identifying or discarding a potentially contaminated chemicals include manually removing a sample of a chemical and taking the sample to a lab for testing. Some methods involve, for example, discarding a cleaning solution after a predetermined period of time, such as twelve hours. Some current methods utilize a liquid based continuous-flow automatic bath analysis system that involves collection of liquid samples from multiple sources. However, these systems involve transporting a sample to an analyzer in liquid form. Once the sample is transported to the analyzer, it is routed to a nebulizer that is associated with the analyzer, and the sample is analyzed to determine concentrations of particular analytes.

Accordingly, known systems involve moving chemicals, in liquid form, from remote baths to a central instrument for analysis. Thus, known methods suffer the limitations of requiring a significant amount of time to move the liquid, either manually or through narrow tubing to an analytical instrument. Further, because liquid is moved through tubing, a significant amount of sample is required to be removed from its useful application to fill the sample tubing from the sample source to the analyzer. Additionally, during the delay between taking a sample and analyzing the sample, if the sampled chemical is contaminated, it can cause significant damage to the thing it was intended to clean, for example. Further, some solutions requiring analysis have a sufficiently high pH that trace elements can precipitate out of the solution in transit to the instrument, resulting in inaccurately low measurements of the trace elements. And while in transport in the tubing, adsorption or precipitation of the analytes inside the transport tubing can occur. Adsorption of analytes usually causes false signals lower than the true value. However, at times the adsorbed analytes will emerge from the transfer line and cause false positive signal spikes. Such inaccuracies can make the analytical results unreliable for process monitoring or process control. Additionally, methods and systems that transport multiple samples to a local nebulizer associated with a single analyzer can cause undesired chemical reactions between the samples as they are sent into the shared nebulizer at different times to be analyzed.

### SUMMARY OF INVENTION

A remote chemical analysis system is provided. The system includes a spectrometer or other detector and at least one remote nebulizer that provides an aerosolized sample through a length of aerosol transport tubing. The length of aerosol transport tubing transports the aerosolized sample over a distance greater than approximately two meters to the spectrometer.

The present invention advantageously uses nebulizers for remote aerosol generation and then transports the aerosol by way of, for example, an argon gas stream through tubing. By transporting the chemical to be analyzed in aerosol form, transport time is reduced from the about 30 minutes required for known systems to less than one minute. In methods and systems consistent with the present invention, even neutral and high pH solutions can be delivered and analyzed without precipitation problems that occur during liquid transport.

### BRIEF DESCRIPTION OF DRAWINGS

These and other inventive features and advantages appear from the following Detailed Description when considered in connection with the accompanying drawings in which similar reference characters denote similar elements throughout the several views and wherein:

FIG. 1 is schematic block diagram of a remote sampling system employing a multiple stream aerosol transport mechanism with an aerosol control valve;

FIG. 2 is a schematic block diagram illustrating a remote sampling system that utilizes a nebulizer control mechanism to specify which remote sample is to be analyzed;

FIG. 3 is a schematic block diagram illustrating a sample extraction system with dilution; and

FIG. 4 is a schematic block diagram illustrating a sample extraction system using gravity.

### DETAILED DESCRIPTION

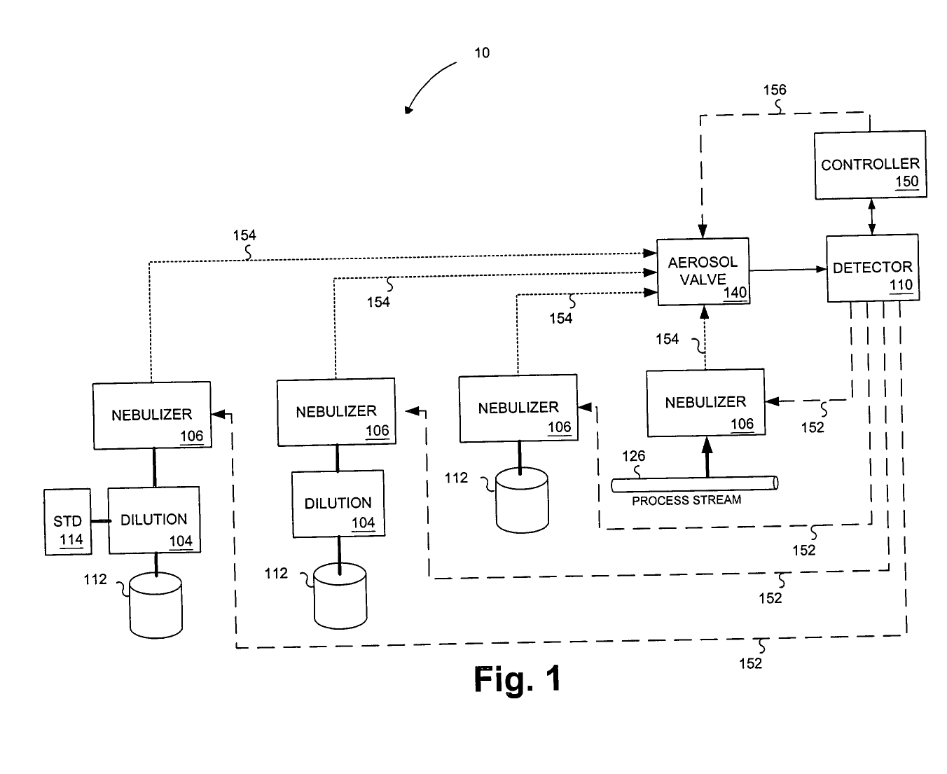

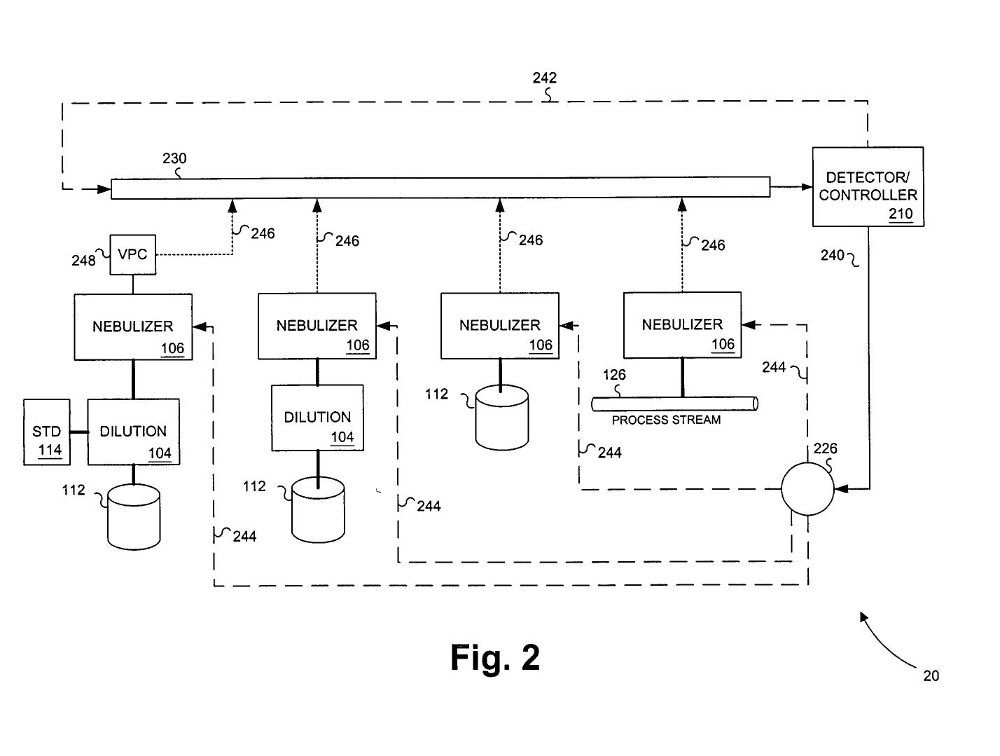

Referring to FIG. 1 and FIG. 2, remote sampling systems 10 and 20 consistent with the present invention involve the use of remote nebulizers 106 to quickly provide samples in aerosol form to a central analyzer or detector 110, allowing the samples to be located at a significant distance from the detector 110, for example in different locations in a semiconductor fabrication or petrochemical manufacturing plant.

An aerosol is a suspension of liquid droplets or solid particles in a gas. A wet aerosol is an aerosol including droplets that are in the liquid phase. A dry aerosol is an aerosol in which there are substantially no suspended liquid droplets. Wet aerosols can also include solid particles that are suspended in dry gases. For example, wet steam is a wet aerosol, because it contains water droplets in the liquid state. Dry aerosol can be produced by aerosolizing a sample at a sufficiently low flow rate that the solvent exists substantially only in the gaseous state. Further, a condensing process can be used to reduce an amount of solvent in an aerosol stream, by, for example, cooling the aerosol stream.

Referring in greater detail to FIG. 1, which is schematic block diagram of a remote sampling system employing a multiple stream aerosol transport mechanism, sample sources 112 are sampled to determine elemental concentration of particular analytes. In one embodiment, the sample source 112 is a chemical bath containing a chemical that is used, for example, to clean semiconductor wafers, during semiconductor fabrication processes. In alternative embodiments, the sample source 112 is any chemical, for which it is useful to determine a concentration of a particular analyte or set of analytes.

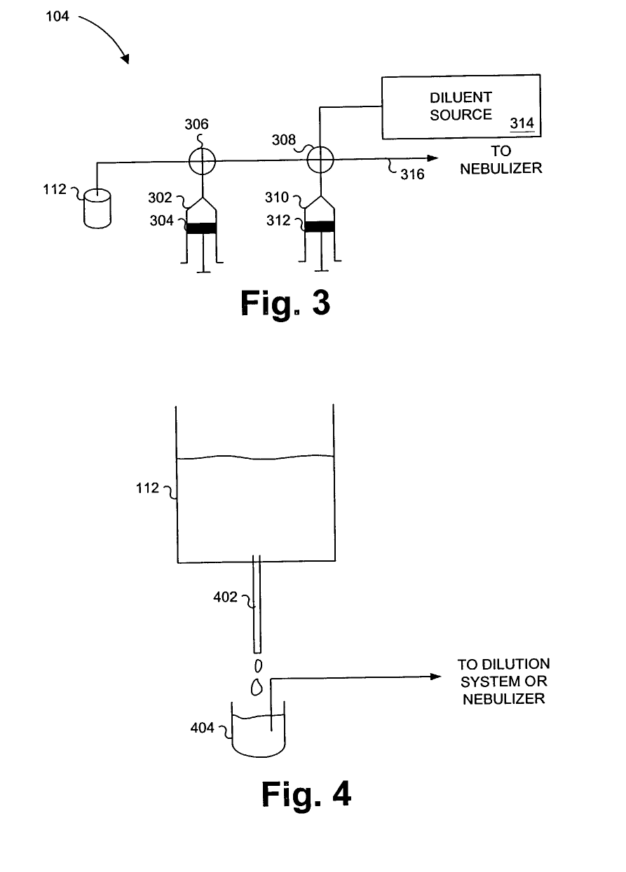

The sample source 112 is sampled using, for example a syringe pump dilution system 104 as illustrated in connection with FIG. 3. The syringe pump dilution system 104 includes a sample valve 306 and diluent valve 308, which are used to facilitate optional dilution of the sample to be analyzed. Some chemicals do not require dilution before aerosilization, such as HF. However, because of their high viscosity, some chemicals, such as sulfuric acid are preferably significantly diluted prior to aerosolization, for example a 10:1 dilution. To accomplish sampling and dilution with the syringe pump system illustrated in FIG. 3, the sample valve 306 is positioned to allow flow of sample from the sample source 112 into sample syringe body 302, when sample syringe plunger 304 is pulled outwardly from the syringe body 302. The sample valve 306 and the diluent valve 308 are positioned to allow diluent from diluent source 314 to flow into diluent syringe body 310 when diluent plunger 312 is pulled outwardly from the diluent syringe body 310. In one embodiment, sample syringe plunger 304 and diluent plunger 312 are controlled by electromechanical positioners that are controlled by an electronic controller, such as controller 150 of FIG. 1.

In the dillution system illustrated in FIG. 3, a dilution ratio is controlled by the ratio of the amount of sample drawn into the sample syringe body 302 to the amount of diluent drawn into the diluent syringe body 310. For example, to accomplish a 10:1 dilution, one unit of sample is drawn into the sample syringe body 302 and 10 units are drawn into the diluent syringe body 310. Next, to provide the diluted sample to a nebulizer, the sample valve 306 and the diluent valve 308 are positioned to allow flow out of the sample and diluent syringes, and the plungers are moved inwardly into the syringe bodies, forcing the contents of the syringes into diluted sample exit passage 316, which is preferably in communication with a nebulizer, such as the nebulizer 106 of FIG. 1. Syringe bodies 302 and 310 are preferably constructed out of Perfluoroalkoxy (“PFA”) Teflon™, and syringe plungers 304 and 312 are preferably constructed out of high purity (“PTFE”) Teflon™ or TFM. However, it is understood that other materials can be used to construct the syringe pumps, such as high purity fluoropolymers.

Referring back to FIG. 1, a dilution system 104, such as the one illustrated in FIG. 3, optionally dilutes a sample from the sample source 112. Further, an internal standard, such as internal standard 114, is optionally introduced. The nebulizer 106 aerosolizes the optionally diluted sample, and transports the aerosol to the aerosol valve 140 through aerosol transport lines 154, indicated by the dotted lines from the nebulizers 106 to the aerosol valve 140. In one embodiment, the nebulizer 106 is a pneumatic nebulizer constructed from PFA Teflon™, such as the nebulizers available from Elemental Scientific, Inc. of Omaha, Nebr. In one embodiment, the aerosol transport lines 154 are constructed from PFA Teflon™ tubing, having an inside diameter of about 5 mm. The aerosol transport lines can range in length from approximately 1 m to approximately 300 m. In alternative embodiments, the aerosol transport lines can have an anti-static exterior sheath, such as a carbon filled polymer sheath, to dissipate electrical charge that could interfere with the flow of suspended analyte particles in the transported aerosol. It is understood that other anti-static mechanisms can be employed to dissipate static electrical charges in the vicinity of the aerosol transport lines 154 without departing from the teachings of the present invention, such as anti-static air shower systems.

In one embodiment, an anti-static film is deposited on the interior of the aerosol transport lines 154, for example by optionally introducing a film of aerosolized, conductive liquid comprising 10% sulfuric acid. In alternative embodiments, other conductive liquids can be used. In one embodiment, the conductive liquid is periodically introduced into the aerosol transport lines. In alternative embodiments, the conductive liquid is combined with the sample to be analyzed in an associated optional dilution step.

Changes in temperature within the aerosol transport lines 154 can interfere with transport. For instance, a relatively cold transfer line could cause condensation of the chemical solvent or optional diluent. Accordingly, in an embodiment, the aerosol transport lines 154 are heated to prevent solvent or diluent condensation within the aerosol stream in the aerosol transport lines 154. In one embodiment, heating of the aerosol transport lines 154 is accomplished by use of resistively heated wire wrapped around the aerosol transport lines 154. The resistively heated wire is preferably enclosed with a PFA Teflon™ sheath to contain heat along the outer portions of the aerosol transport lines. It is understood that other mechanisms for heating the aerosol transport lines 154 can be employed without departing from the teachings of the present invention, such as light source heating systems, or forced air heating mechanisms.

The aerosol control valve 140 selects which aerosol stream is directed into detector 110. The aerosol control valve 140 is preferably constructed from PFA Teflon™ and other high purity fluoropolymers, but it is understood that other materials can be used to construct the aerosol valve without departing from the teachings of the present invention. The detector 110 analyzes the elemental chemical makeup of the aerosol selected by the aerosol valve 140. In one embodiment, the detector is an inductively coupled plasma mass spectrometer (“ICP-MS”). ICP-MS processes result in a signal corresponding to particular elements to be transmitted from the detector 110 to the controller 150, which performs calibration calculations, data logging functions, and real time display and output of the concentrations of particular chemicals or elements in the samples.

In one embodiment, the controller 150 is a general purpose computer system programmed to receive signal information from the detector and to control operation of the detector. In this embodiment, controller 150 has a conventional display, such as a cathode ray tube or a liquid crystal display monitor. The controller 150 also has user input mechanisms, such as a keyboard and mouse. In an embodiment, a touch screen user interface is used.

In one embodiment, the detector 110 provides argon gas streams through nebulizer control lines 152 to the nebulizers 106 to elicit the pneumatic generation of aerosol. In alternative embodiments, non-pneumatic nebulizers are used, such as ultrasonic nebulizers, which are electrically controlled, using piezoelectric elements to generate aerosol. In these embodiments, the nebulizer control lines 152 are electrical or fiber-optical control signals, or other telecommunication control signals, such as wireless signals, used to control the ultrasonic nebulizers. In FIG. 1, the nebulizer control lines are illustrated as being connected to detector 110, however they can alternatively be connected to controller 150, because controller 150 and detector 110 operate in concert. In one embodiment, make-up gas is provided via make-up gas line to aerosol valve 140 or to aerosol transport lines 154 to facilitate aerosol transport from the nebulizers 106 through the aerosol valve 140 to the detector 110 for analysis.

The embodiment illustrated in FIG. 1 advantageously facilitates the remote sampling of diversely located sample sources using various techniques. A diluted sampling system has been described, and other sampling mechanisms are illustrated in FIG. 1, including dilution with an internal standard as illustrated in connection with the standard 114 labeled STD in FIG. 1. The internal standard is advantageously used to compensate for differences between different nebulizers and differences in the nebulizers 106, the aerosol transport line 154, and the aerosol valve 140 over time and at different temperature or atmospheric conditions. By introducing a standard in real time, any inconsistencies can be compensated for in real time by comparing the signal strength, associated with the standard, at the detector with the known concentration of the standard 114. The standard can be introduced into the sample to be aerosolized using, for example, a syringe pump and valve system as illustrated in connection with the dilution system shown in FIG. 3. It is understood, that the diluent itself can be used as an internal standard.

In one embodiment, an element, such as yttrium, is used as an internal standard to facilitate compensating for differences in transported analyte. In another embodiment, an isotope of the analyte is used as a standard to facilitate more robust compensation.

Further, using a self-aspirating, pneumatic nebulizer for at least one of the nebulizers 106, a sample can be directly obtained from the sample source 112. Additionally, gravity can be used to obtain a sample as illustrated in connection with FIG. 4, in which a small diameter tube 402 is connected to the bottom of the sample source 112, causing a predetermined amount of sample to drip into a sample collection vessel 404 from which the sample can be collected. In this way, any possibility of back contamination is substantially reduced from, for example, a syringe pump dilution and/or internal standard system, if, for example, the sample control valve 306 of FIG. 3 were to fail. It is understood that alternative means of obtaining samples from the sample sources 112 can be employed without departing from the teachings of the present invention. Means for extracting a chemical sample include, for example: (i) syringe pump systems with optional dilution and internal standards; (ii) gravity based sample extraction systems; and (iii) other pump-based sample extraction systems.

Referring again to FIG. 1, in the context of the petrochemical industry, process streams such as process stream 126 can be remotely analyzed using a central analyzer in connection with the present invention. A sample is obtained from the process stream 126 and aerosolized by the nebulizer 106. Next, the aerosol is transported on the aerosol transport line 154 through the aerosol valve 140 to the detector.

FIG. 2 is a schematic block diagram illustrating a remote sampling system 20 that utilizes a nebulizer control mechanism 226 to specify which remote sample is to be analyzed. In this embodiment, sample sources 112 and process streams 126 are remotely analyzed using detector/controller 210, which is preferably constructed from a detector and controller analogous to those described in connection with FIG. 1. The detector/controller 210 preferably includes a detector and general purpose computer programmed to control the operation of the detector and to receive signal information from the detector. The associated detector and controller can be located proximate to each other, implemented in the same unit, or located remotely from each other using known computer peripheral communication and/or networking techniques.

The embodiment illustrated in FIG. 2 selectively enables nebulizers 106 to direct aerosol into aerosol manifold 230 to transport aerosol to the remote detector/controller 210. A sample is extracted from the sample source 112 using, for example a sample extraction and dilution system 104 as described in connection with FIG. 3, to provide an aerosolized sample to the detector/controller 210 through the aerosol manifold 230. In one embodiment, the detector/controller 210 controls nebulizer selector 226 to enable the desired nebulizer 106 to transport aerosol into the aerosol manifold 230 by way of aerosol transport line 246. The aerosol transport line 246 is analogous to the aerosol transport line 154 of FIG. 1, and analogously to aerosol transport line 154, it can be advantageously heated or provided with anti-static properties. The aerosol transport lines 154 and 246 are an example of means for transporting an aerosolized sample. Alternative and/or additional means for transporting aerosol include aerosol manifold 230 and aerosol valve 140 of FIG. 1.

In one embodiment, nebulizer selector 226 a valve used to selectively provide an inert gas stream, for example an argon gas stream, to a selected one of the nebulizers 106 to activate the selected nebulizer, thereby providing aerosol to the aerosol manifold 230. The detector/controller 210 preferably provides make-up gas by way of make-up gas line 242 that transports the aerosol from the selected aerosol sample in the aerosol manifold to the detector/controller 210. In one embodiment, nebulizer control paths 244 are gas lines that selectively receive gas, for example argon gas, through the nebulizer selector 226, which in an embodiment, is a gas valve that is controlled by the detector/controller 210 to select a particular sample from one of the sample sources 112 or process streams 126. In alternative embodiments, nebulizers are non-pneumatic nebulizers, for example, ultrasonic nebulizers. In this embodiment, nebulizer selector 226 is a selector other than a gas valve, for example a multiplexer, that transmits signals along the nebulizer control paths 244, which can be electrical lines, fiber-optical lines or other control lines, such as wired or wireless telecommunications lines.

In one embodiment a vapor pressure controller (“VPC”) 248 is used to provide condensation of a solvent or diluent to reduce, for example solvent concentration in the generated aerosol. In an embodiment, the VPC 248 is a solid state cooling apparatus. In alternative embodiments the VPC 248 is an inert membrane. A means for converting a sample into aerosol form is, for example, a nebulizer of the various types described above, and such means can optionally include a vapor pressure controller such as the VPC 248.

In one embodiment, only a single bath or chemical is monitored. In alternative embodiments, multiple baths or streams are monitored. In one embodiment, an additional gas flow is added via make-up gas line 242 to continually or intermittently purge the aerosol manifold 230, thereby flushing out any remaining aerosol from previously selected and analyzed samples. Accordingly, means for transporting an aerosolized sample optionally includes a makeup gas line.

Calibration

When using various types of detectors 110, calibration is useful to compensate for differences between nebulizers 106 and systematic variations throughout remote sampling systems consistent with the present invention. Calibration is a process of defining an expected relationship between detector signal and analyte concentration. For example in ICP-MS systems, the signal to concentration relationship is substantially linear, and in this case calibration can be performed, for example with two National Institute of Standards and Technology (“NIST”) traceable standards to obtain calibration parameters corresponding to a particular nebulizer and transport configuration. In one embodiment, calibration parameters are stored in connection with a controller so that signals received at the controller can be scaled to provide an accurate indication of analyte concentration within the sample. In one embodiment, NIST traceable standards are located proximate to sample sources, so that calibration parameters can be recalculated on a predetermined basis during the ongoing operation of remote autosampling systems consistent with the present invention.

An exemplary autocalibration process works as follows. When using detectors that are known to have substantially linear signal to concentration relationships, two NIST traceable standards are sampled, and signals corresponding to the standard concentrations are stored in the controller. In an embodiment, parameters representing the signal to concentration relationship are stored as a line slope and offset. In an embodiment, known statistical methods are employed to facilitate accurate calculation of calibration parameters. In connection with detectors other than ICP-MS systems, such as flame-based detectors, the signal to concentration relationship is non-linear. In such a case, it can be advantageous to use significantly more than two standards, to calculate calibration parameters that can be used to represent the signal to concentration relationship. Further, as discussed above, once a nebulizer and transport path are calibrated, internal standards are optionally employed to facilitate comparison of received signal of a standard of known concentration to the expected signal based on current calibration. Accordingly, the optional internal standard can be used to correct or refine calibration parameters in real-time.

In one embodiment, a separate nebulizer and spray chamber is used for each bath. In alternative embodiments, baths that are in close proximity share a nebulizer and sample extraction system, using for example a local autosampler to extract samples from sample extraction vessels that are drip-filled using a gravitational sample extraction process analogous to the gravitational system illustrated in connection with FIG. 4.

Detectors

As described above, a presently preferred embodiment utilizes an ICP-MS instrument to implement detector 110. However, the novel teachings of the present invention are not dependent on the useful characteristics of the ICP-MS instrument. Accordingly, any type of chemical analyzer can be used consistent with the teachings of the present invention. Examples of such detectors include (i) inductively coupled plasma optical emission spectroscopy (“ICPAES”); (ii) electrospray mass spectrometry; (iii) flame spectrometry; (iv) electrochemical detection; or (v) other processes for identifying the chemical composition of a sample.

Accordingly, means for determining a concentration of trace elements includes a detector and, optionally, at least one controller with associated optional calibration systems including various standards.

While exemplary embodiments and particular applications of this invention have been shown and described, it is apparent that many other modifications and applications of this invention are possible without departing from the inventive concepts herein disclosed. It is, therefore, to be understood that, within the scope of the appended claims, this invention may be practiced otherwise than as specifically described, and the invention is not to be restricted except in the spirit of the appended claims. Though some of the features of the invention may be claimed in dependency, each feature has merit if used independently.

1. A remote chemical analysis system comprising:
a detector;
at least one remote nebulizer operable to provide an aerosolized sample to at least one length of aerosol transport tubing; and
the length of aerosol transport tubing operable to transport the aerosolized sample over a distance greater than approximately two meters to the detector.

2. The system according to claim 1 further including an aerosol switching valve in communication with the detector.

3. The system according to claim 1 further including a nebulizer selector operable to selectively enable the at least one remote nebulizer.

4. The system according to claim 1, wherein, the aerosolized sample includes wet aerosol.

5. The system according to claim 1, wherein, the aerosolized sample includes dry aerosol.

6. The system according to claim 1, wherein, the distance is less than approximately three hundred meters.

7. The system according to claim 1, wherein, the length of aerosol transport tubing is heated.

8. The system according to claim 1, wherein, the length of aerosol transport tubing is provided with anti-static properties.

9. The system according to claim 1, wherein, the length of aerosol transport tubing is coated with an anti-static film.

10. The system according to claim 1 further including a pre-condenser operable to condense a solvent associated with the aerosolized sample.

11. The system according to claim 1 further including a diluter.

12. The system according to claim 11, wherein, the diluter is operable to prevent back contamination.

13. The system according to claim 11, wherein, the diluter includes a syringe pump.

14. The system according to claim 13, wherein, the syringe pump is a PFA syringe pump.

15. The system according to claim 13, wherein, the syringe pump has flexible walls and a solid plunger.

16. The system according to claim 1 further including a calibration system operable to individually calibrate stations associated with at least one sample source.

17. The system according to claim 1 further including a spray chamber.

18. The system according to claim 1, wherein the detector is an ICP-MS instrument.

19. The system according to claim 1, wherein the detector is an ICP-AES instrument.

20. The system according to claim 1, wherein the detector is an electrospray mass spectrometer.

21. The system according to claim 1, wherein the detector is a flame.

22. The system according to claim 1, wherein the detector is an electrochemical detector.

23. A remote chemical analysis system comprising:
a detector;
at least one remote nebulizer operable to provide an aerosolized sample to at least one aerosol transport line;
the aerosol transport line operable to contain the aerosolized sample and to selectively transport the aerosolized sample over a distance greater than two meters through an aerosol manifold to the detector; and
a nebulizer controller operable to selectively enable the remote nebulizer to provide the aerosolized sample to the detector.

24. The system according to claim 23, wherein, the aerosolized sample includes wet aerosol.

25. The system according to claim 23, wherein, the aerosolized sample includes dry aerosol.

26. The system according to claim 23, wherein, the distance is less than approximately three hundred meters.

27. The system according to claim 23, wherein, the aerosol transport line is heated.

28. The system according to claim 23, wherein, the aerosol transport line is constructed from an anti-static material.

29. The system according to claim 28, wherein, the anti-static material includes a carbon filled polymer.

30. The system according to claim 23 further including a pre-condenser operable to condense a solvent associated with the aerosolized sample.

31. The system according to claim 23 further including a diluter.

32. The system according to claim 31, wherein, the diluter is operable to prevent back contamination.

33. The system according to claim 31, wherein, the diluter includes a syringe pump.

34. The system according to claim 33, wherein, the syringe pump is a PFA syringe pump.

35. The system according to claim 33, wherein, the syringe pump has flexible walls and a solid plunger.

36. The system according to claim 23 further including a calibration system operable to individually calibrate stations associated with at least one sample source.

37. The system according to claim 23 further including a spray chamber.

38. The system according to claim 23, wherein the detector is an ICP-MS instrument.

39. The system according to claim 23, wherein the detector is an ICP-AES instrument.

40. The system according to claim 23, wherein the detector is an electrospray mass spectrometer.

41. The system according to claim 23, wherein the detector is a flame.

42. The system according to claim 23, wherein the detector is an electrochemical spectrometer.

43. A remote chemical analysis system comprising:
a detector;
at least one remote nebulizer operable to provide an aerosolized sample to at least one aerosol transport line;
the aerosol transport line operable to contain the aerosolized sample and to transport the aerosolized sample over a distance greater than two meters through an aerosol control valve to the detector; and
a gas source operable to provide gas to the aerosol transport line to transport the aerosolized sample to the detector.

44. A method of remotely monitoring purity of a chemical, the method comprising:
receiving a sample of the chemical to analyze;
converting the sample to an aerosol;
transporting the aerosol through at least two meters of aerosol transport tubing to a detector; and
determining a concentration of at least one elemental contaminant in the chemical.

45. The method as set forth in claim 44 further comprising purging the aerosol from an aerosol manifold coupled with the aerosol transport tubing.

46. A remote auto-sampling system comprising:
means for extracting a sample of a chemical to analyze;
means for converting the sample into aerosol form, resulting in an aerosolized sample;
means for transporting the aerosolized sample through at least two meters of aerosol transport line to a means for analyzing the chemical; and
means for determining a concentration of trace elemental contaminants in the chemical.
